(19) United States
(12) Patent Application Publication
(10) Pub. No.: US 2025/0005558 A1
(43) Pub. Date: Jan. 2, 2025

(54) ELECTRONIC ACCOUNT GENERATION SYSTEM

(71) Applicant: NIFTY CHESS, INC., MEMPHIS, TN (US)

(72) Inventors: Joseph Domenic Schiarizzi, Falls Church, VA (US); Patrick William Gallagher, Memphis, TN (US); Sascha Mombartz, MEMPHIS, TN (US)

(73) Assignee: NIFTY CHESS, INC., MEMPHIS, TN (US)

(21) Appl. No.: 18/214,994

(22) Filed: Jun. 27, 2023

(51) Int. Cl. G06Q 20/36; G06Q 20/10; G06Q 20/38

(52) U.S. Cl. CPC G06Q 20/3672; G06Q 20/10; G06Q 20/3829; G06Q 20/389

(57) ABSTRACT

An electronic method includes receiving, by a computing device, electronic information associated with an electronic account that is not associated with any blockchain or Web-3. The electronic method further includes generating, by the computing device, an electronic wallet based on the electronic information, wherein the electronic wallet is associated with a particular blockchain and wherein the electronic wallet is associated with another electronic account.

### BACKGROUND

At the present time, if one user wishes to send another user electronic information, that can be used for other electrical communications (such as associated with Web3), the other user requires a particular type of electronic account that permits receipt of the second electronic information. However, there is no system that allows one of user to send the electronic information to another user if the other has not created their own electronic account.

### BRIEF DESCRIPTION OF DRA WINGS

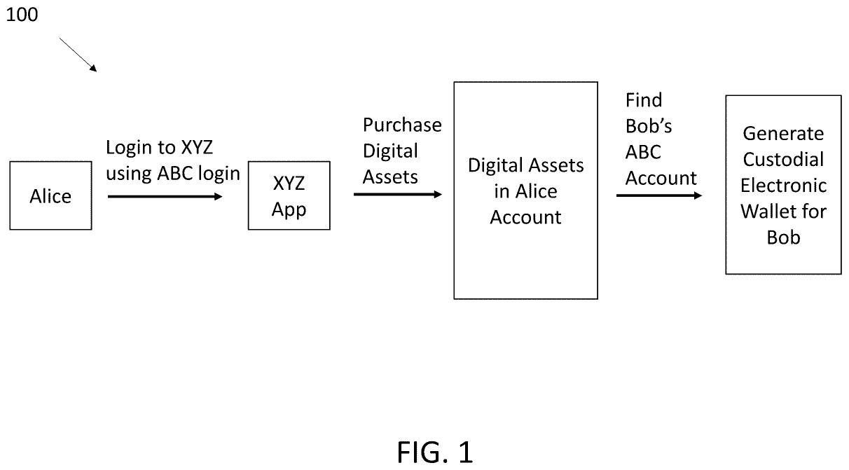

FIG. 1 is an example diagram of generating an electronic account;

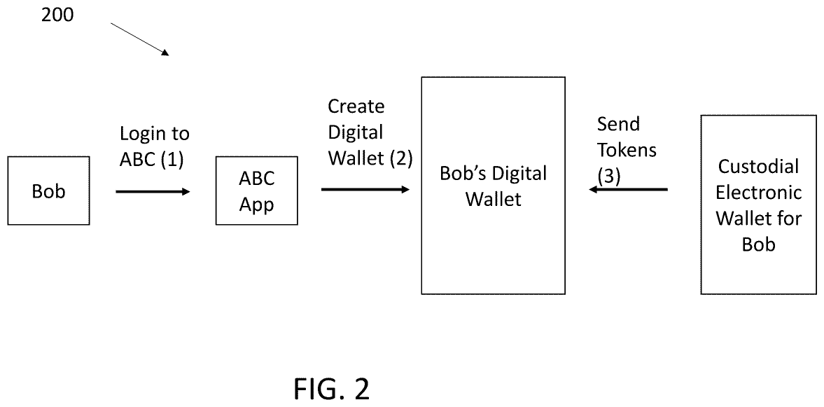

FIG. 2 is an example diagram of sending electronic information;

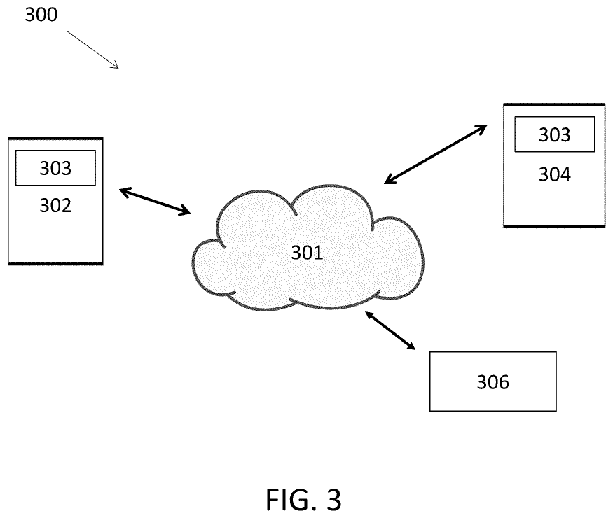

FIG. 3 is a diagram of a network environment;

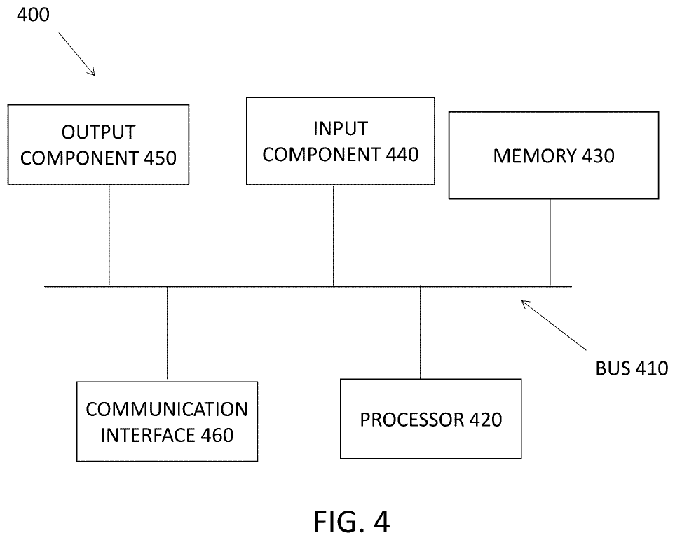

FIG. 4 is a diagram of an example computing device;

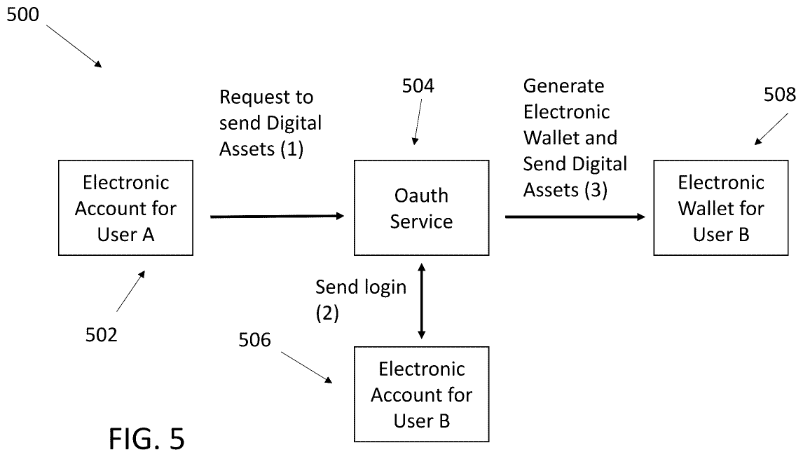

FIG. 5 is an example diagram of generating an electronic account;

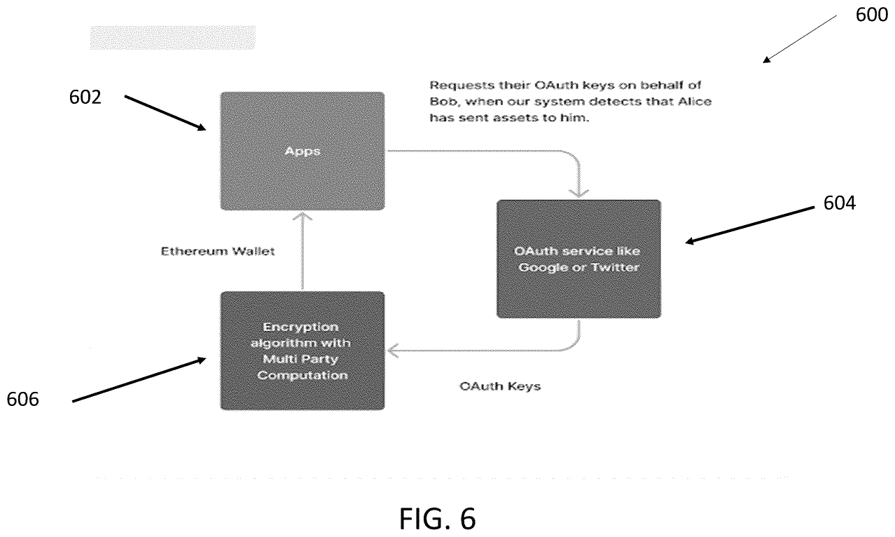

FIG. 6 is an example diagram of generating an electronic account;

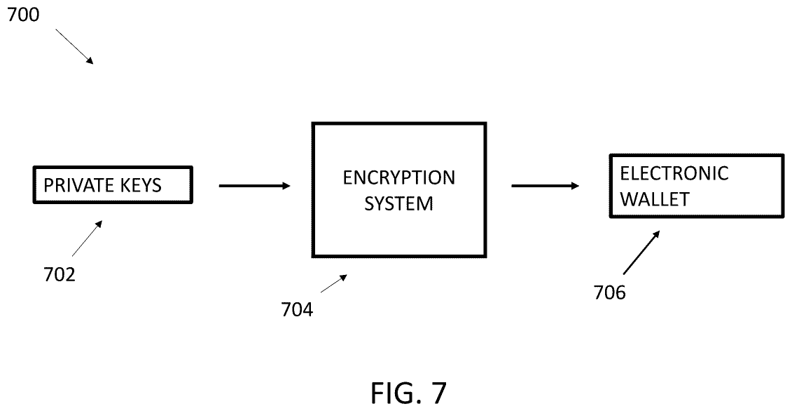

FIG. 7 is an example diagram of generating an electronic account;

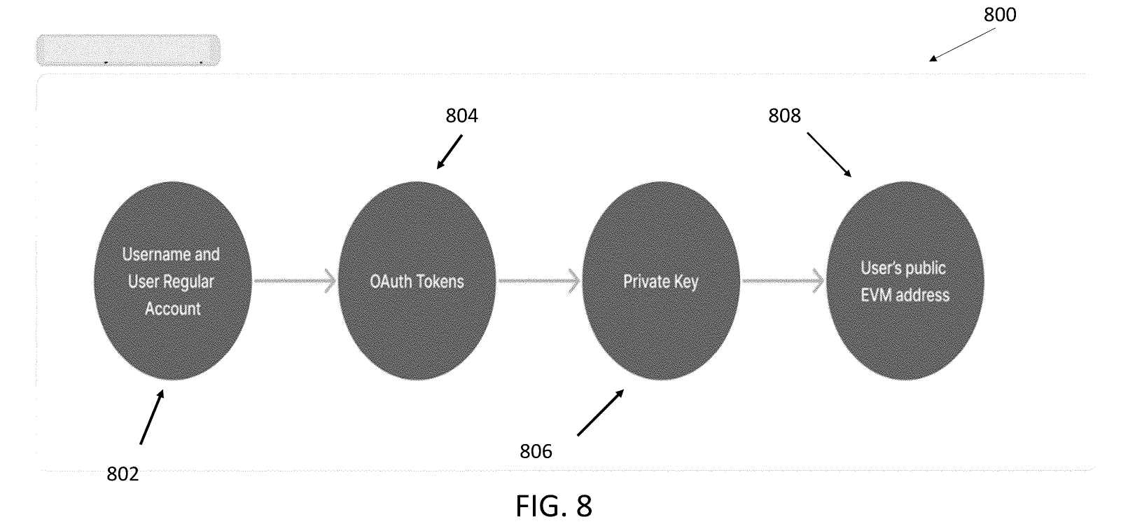

FIG. 8 is an example diagram of generating an electronic account; and

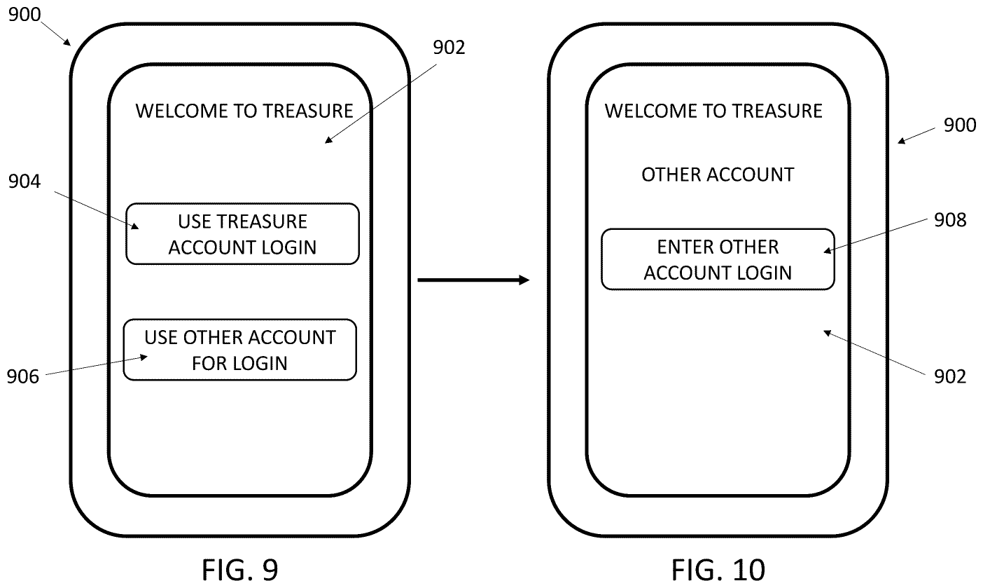

FIGS. 9-18 are example diagrams of generating an electronic account and sending electronic information.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for generating an electronic account for the purposes of receiving electronic information without the need for the person, for whom the electronic account is being generated for, to be directly involved in the generation of the electronic account. In embodiments, the electronic account may be generated on the basis of another electronic account (associated with the same user) such that the other electronic account is a non-blockchain or non-Web3 while the electronic account being generated may be a blockchain or Web3-based account.

Thus, the systems, devices, and/or methods described herein allow for a user of a particular electronic application to send electronic information (e.g., tokens) to another user without that other user (a) having an electronic account associated with the particular electronic application, (b) receiving a notification prior to the generation of the electronic account for that other user, (c) requiring any electronic inputs from that other user, or (d) having any electronic tokens or other types of electronic features prior to the creation of the blockchain or Web3-based electronic account.

In embodiments, when the user logs into a particular electronic application, the user may use login information from another account or login information for that particular electronic application. For example, if the user is logging into ABC application, the user may use the login information associated with XYZ. Once logged in, the user may decide to obtain electronic tokens (that may be purchased with actual currency via an electronic communication or provided as part of a game or other service associated with the particular electronic application). In this non-limiting example, the user may then wish to electronically transfer the electronic tokens to a friend (e.g., another user). However, the other user may not have an electronic account associated with ABC. Furthermore, the type of account required to obtain the electronic tokens may be a blockchain-based account.

In this non-limiting example, the user is aware that their friend has account on a particular electronic social network (which may be associated with the XYZ application or may have no relationship to the XYZ application). The user then uses that friend's account to generate an electronic account on the particular electronic generation and permitting the user to then send electronic tokens to that newly generated account (which in this example is a blockchain-based account).

Accordingly, systems, devices, and/or methods allow (1) the ability to create an electronic wallet (i.e., digital, computer-based) using an identifier that the recipient has chosen unrelated to Web3 and blockchain technology (e.g., an electronic handle, an email address or any social media username, etc.), (2) the ability to receive electronic information (e.g., an electronic token, currency, etc.) in a digital asset wallet, (3) the ability to send a digital asset that is not dependent on the recipient already having a wallet, and (4) only a single action from the sender is required to create the electronic wallet without continued involvement by the sender in the transfer process of the digital (i.e., electronic) information (e.g., assets such as tokens, non-fungible units (NFTs), bitcoins, etc.).

In embodiments, the systems, devices, and/or methods described herein allow for one user to send electronic tokens to another user before the other user has logged in or created any type of account by themselves. Furthermore, the other user does not require any electronic notification that electronic tokens were sent by the user. Thus, the other user has an electronic wallet created before the other user has interacted in any way with the web3 application, the associated blockchain, and the created electronic wallet. In embodiments, the other user can then access the electronic wallet at the time that the other user logs into their electronic account and is notified of the electronic assets. Accordingly, within a blockchain or web3 environment, a user can interact with other users via user names (or other types of identifications such as phone numbers, biometric information, passwords, social media pseudonyms, etc.) when sending electronic tokens, NFTs, etc., which is contrast to a blockchain environment where user names are not supported.

In contrast to the systems, devices, and/or methods described herein, other systems require the user sending the NFT or asset to another user needs to know the wallet address of the recipient in advance to successfully send the asset. As such, other systems do not allow for instantaneous transfers because each individual must have a digital wallet already created to make transactions or to receive digital assets. Furthermore, the creation of digital wallets requires special knowledge and skills that are not necessary with the creation of an electronic wallet as described herein. In addition, other systems do not combine the capabilities of web3 with non-blockchain electronic accounts (such as social networking electronic applications).

Instead, the systems, devices, and/or methods described herein, create ease of access by creating a wallet for the recipient without needing a special wallet address and instead using another form of unique identity to send assets through the blockchain. Accordingly, the moving of the digital assets from one electronic account to another can be done without expertise in creating wallets or the blockchains. Thus, the systems, devices, and/or methods described herein allow users without existing Web3 (or blockchain) wallets to access and enjoy the same applications that users with Web3 (blockchain) wallets.

FIG. 1 shows an example generation process 100 of a digital wallet. As shown in FIG. 1, Alice decides to log into her XYZ account using her login credentials from her ABC account. Once logged into her XYZ account, Alice decides that she would like to purchase an electronic assets (such as non-fungible token)). As shown in FIG. 1, Alice has now purchased electronic assets and are now part of her XYZ account. Alice then decides that she wishes to send some of the digital assets to Bob. However, Bob does not have an electronic wallet or a public address on a blockchain to obtain the electronic wallet.

Instead, Bob does have an ABC account. Based on Bob having an ABC account, Alice uses Bob's ABC account credentials (without Alice knowing Bob's ABC account login credentials) by searching for Bob's ABC account via the ABC application. Upon finding Bob's ABC account username, Alice using the systems, devices and/or methods described herein to generate an electronic wallet for Bob based on Bob's ABC account. In embodiments, every public address may be derived from a private key by taking the Keccak-256 (a popular open source hashing algorithm) of a private key to get a 32 byte long string, and then removing the first 12 bytes of that resulting string. In embodiments, adding a “0x” prefix may make it easier to identify. An example public address is 0x6D33C10eF04ADF140d4458D24cac690c677d5bE2. Thus, an electronic custodial wallet for Bob generated, as shown in FIG. 1, Alice will now be able to electronically transfer digital assets from her electronic account to Bob's electronic custodial wallet.

FIG. 2 shows an example transfer 200 of digital assets. As shown in FIG. 2, Bob logs into his XYZ account. In embodiments, the XYZ account can be an email, a phone number, or any other unique identifiable way to say who a user is. In embodiments, this enables sending digital assets to people before they have a wallet setup to create viral feedback loops and improve user experience. Once he is logged into his XYZ account, an electronic wallet is generated for Bob based on logging into XYZ and the creation of the custodial account. In addition, upon logging into the ABC account, the digital assets from Bob's custodial electronic wallet are transferred to During the transfer of the digital assets from the custodial account, Alice is not providing any additional electronic information.

While FIGS. 1 and 2 show one example of transferring digital assets, the generation of the electronic wallet and the transfer of digital assets can be conducted differently. In another non-limiting example, Alice has signed into XYZ using her login information from ABC. In embodiments, the keys from the XYZ account are used to generate an Ethereum address and a private key for Alice's XYZ account. In this other non-limiting example, Alice buys a non-fungible token (NFT) on XYZ. Once purchased, Alice wants to send an NFT to her friend Bob. However, Bob has not signed into XYZ and does not have a wallet or public address on any blockchain; but, Bob does have an ABC account and username.

In this other non-limiting example, Alice can use the systems, methods, and/or device to search for Bob's ABC username and gives XYZ permission to move the asset by signing a message with her private key to move the asset from her electronic wallet to Bob's electronic wallet once it is generated. At this stage, in this non-limiting example, the NFT is not moved but the transaction details are stored in a XYZ database and no further electronic interaction occurs via Alice's electronic account.

In this other non-limiting example, once Bob logs into his ABC account, the XYZ application creates an electronic wallet for Bob by using his ABC user name to generate an Ethereum address and a private key for Bob's Treasure account. In embodiments, the ABC account can be a social networking account, an email, a phone number, or any other unique identifier associated with the user. This enables sending assets to people before they have a wallet setup to create viral feedback loops and improve user experience. Once Bob's electronic wallet is generated, the XYZ application transfers the NFTs from Alice's electronic wallet to Bob's electronic wallet automatically using the details stored in the database. Alice does not have to make any additional transactions to move the asset. Instead, as described above, the transaction is facilitated by the XYZ application.

In an additional non-limiting example, Alice has signed into the XYZ application with her existing ABC user account. In this additional non-limiting example, keys from the ABC account (Alice's account) are used to generate an Ethereum address & a private key for her XYZ account. In this non-limiting example, Alice buys an NFT. Alice then wants to electronically send the NFT to her friend Bob. However, Bob has not signed into the XYZ application, and does not have an electronic wallet or public address on any blockchain, but he does have an ABC account username. Alice can use the systems, methods, and/or devices described herein to search for Bob's ABC username. After selecting Bob's username, XYZ generates a wallet for Bob by using his ABC username to generate an Ethereum address and a private key for Bob's XYZ account. The generation of the electronic wallet for Bob occurs without any electronic inputs from Bob. Thus, Bob does not need to sign into XYZ for a wallet to be created on his behalf. Once Alice submits her transaction, Treasure uses Bob's address to complete the transfer. Once Bob logs into XYZ with his ABC account, Bob will be provided electronic communications that display an electronic wallet with the NFT sent by Alice (via the XYZ application).

FIG. 3 is a diagram of example environment 300 in which systems, devices, and/or methods described herein may be implemented. FIG. 3 shows network 301, application 303, user device 302, user device 304, and application 306.

Network 301 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 301 may include a cellular network, a public land mobile network (PLMN), a second generation (2G) network, a third generation (3G) network, a fourth generation (4G) network, a fifth generation (5G) network, and/or another network.

In embodiments, network 301 may allow for devices describe any of the described figures to electronically communicate (e.g., using emails, electronic signals, URL links, web links, electronic bits, fiber optic signals, wireless signals, wired signals, etc.) with each other so as to send and receive various types of electronic communications.

User device 302 and/or 304 may include any computation or communications device that is capable of communicating with a network (e.g., network 301). For example, user device 302 and/or user device 304 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 302 and/or 304 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 302 and/or 304. User device 302 and/or 304 may have a touch screen and/or a keyboard that allows a user to electronically interact with an electronic application. In embodiments, a user may swipe, press, or touch user device 302 and/or 304 in such a manner that one or more electronic actions will be initiated by user device 302 and/or 304 via an electronic application.

User device 302 and/or 304 may include a variety of applications, such as, for example, a wallet generation application, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.).

Electronic application 303 may be capable of interacting with user device 302, user device 304, and/or wallet generation system 306 to automatically and electronically receive electronic information for one or more persons. In embodiments, electronic application 303 may be electronically configured to generate electronic assets that may be sent to electronic application 306. While FIG. 3 shows electronic application 303 on user device 302 and user device 304, some or all the electronic processes performed by electronic application 303 may be stored by wallet generation system 306.

Wallet generation system 306 may include one or more computational or communication devices that gather, process, store, and/or provide information relating to one or more electronic pages associated with electronic application 303 that is searchable and viewable over network 201. In embodiments, wallet generation system 306 may include one or more servers. In embodiments, the one or more servers of wallet generation system 306 may include one or more databases. In embodiments, wallet generation system 306 may generate an electronic wallet based on information from electronic application 303. In embodiments, wallet generation system 306 may include one or more systems described in FIGS. 5, 6, 7, and/or 8 (e.g., such as a described OAuth system 604, encryption system 704, process 800 as shown in FIG. 8).

FIG. 4 is a diagram of example components of a device 400. Device 400 may correspond to user device 302, user device 304, and wallet generation system 306. Alternatively, or additionally, user device 302, user device 304, and wallet generation system 306 may include one or more devices 400 and/or one or more components of device 400. As shown in FIG. 4, device 400 may include a bus 410, a processor 420, a memory 430, an input component 440, an output component 450, and a communications interface 460. In other implementations, device 400 may contain fewer components, additional components, different components, or differently arranged components than depicted in FIG. 4. Additionally, or alternatively, one or more components of device 400 may perform one or more tasks described as being performed by one or more other components of device 400.

Bus 410 may include a path that permits communications among the components of device 400. Processor 420 may include one or more processors, microprocessors, or processing logic (e.g., a field programmable gate array (FPGA) or an application specific integrated circuit (ASIC)) that interprets and executes instructions. Memory 430 may include any type of dynamic storage device that stores information and instructions, for execution by processor 420, and/or any type of non-volatile storage device that stores information for use by processor 420. Input component 440 may include a mechanism that permits a user to input information to device 400, such as a keyboard, a keypad, a button, a switch, voice command, etc. Output component 450 may include a mechanism that outputs information to the user, such as a display, a speaker, one or more light emitting diodes (LEDs), etc.

Communications interface 460 may include any transceiver-like mechanism that enables device 400 to communicate with other devices and/or systems. For example, communications interface 460 may include an Ethernet interface, an optical interface, a coaxial interface, a wireless interface, or the like.

In another implementation, communications interface 460 may include, for example, a transmitter that may convert baseband signals from processor 420 to radio frequency (RF) signals and/or a receiver that may convert RF signals to baseband signals. Alternatively, communications interface 460 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 460 may connect to an antenna assembly (not shown in FIG. 4) for transmission and/or reception of the RF signals. The antenna assembly may include one or more antennas to transmit and/or receive RF signals over the air. The antenna assembly may, for example, receive RF signals from communications interface 460 and transmit the RF signals over the air, and receive RF signals over the air and provide the RF signals to communications interface 460. In one implementation, for example, communications interface 360 may communicate with network 401.

As will be described in detail below, device 400 may perform certain operations. Device 400 may perform these operations in response to processor 420 executing software instructions (e.g., computer program(s)) contained in a computer-readable medium, such as memory 430, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

FIG. 5 is an example diagram for creating an electronic account (e.g., an electronic wallet). As shown in FIG. 5, user A has an electronic account that is an electronic wallet or associated with an electronic wallet. For example, user A's electronic account may be associated with UVW electronic application. In embodiments, user A may send electronic communications within their electronic account to purchase a digital asset (e.g., an NFT, bitcoin, or any other type of electronic transferable item) within UVW electronic application. In embodiments, the digital asset may be purchased with credit card, fiat currency, or other types of digital currency.

Once purchased, user A may decide to send a portion or all of the digital asset to user B. However, user B does not have an account associated with electronic application UVW. In this non-limiting example, user A has information about electronic account information associated with user B that is associated with another electronic application. In embodiments, user B's electronic application may be an email account, a social networking account, a VoIP (voice over internet protocol) account, a wireless phone account, and/or any other account that requires electronic login credentials (i.e., an electronic account that has digital identity and/or password electronic information). In this non-limiting example, the account is a VoIP account user name.

As shown in FIG. 5, user A may request to send digital assets to user B as shown in communication (1). In this non-limiting example, communication (1) is sent to the OAuth Service associated with user B's account information. Upon receiving communication (1), the transaction information is stored in a database associated with the UVW electronic application. In addition, communication (1) also includes a request for user B's private keys that are associated with user B's VOIP account.

In this non-limiting example, when user B logs into their social networking account 506, communication (2) is sent to OAuth Service 504. In embodiments, OAuth Service 504 may be associated with user B's electronic account 506. Upon receiving user B's login information in communication (2), an electronic wallet is generated for user B (as shown by communication (3)) based on the private keys associated with user B's account that is used within an encryption algorithm (having multiparty computation). Once the electronic wallet for user B is created, digital assets are transferred from user A's electronic wallet to user B's electronic wallet 508. In embodiments, when user B logs into electronic account 508, user B may receive an electronic message, displayed within electronic account 508, that user A has sent digital assets to a wallet that is in user B's name and only allows user B to access (and does not allow user A to access). In embodiments, user B may then retrieve the digital assets in the electronic wallet and purchase other items via the blockchain based on the electronic wallet.

For FIG. 5, in embodiments, the electronic wallet may be associated with a blockchain which allows user A to send digital assets from their electronic account to the electronic wallet generated for user B. In embodiments, the generated electronic wallet, electronic wallet 508, may be associated with an Ethereum address and a private key.

FIG. 6 is an example process 600 for generating an Ethereum wallet. As shown in FIG. 6, application 602 has received a request from a user (such as user A) to generate the Ethereum wallet for another user (such as user B). In embodiments, application 602 requests the OAuth keys for the other user (such as user B) from OAuth service 604 (e.g., a social networking system, an email service, etc., associated with wallet generation system 306) based on the user making the electronic request to generate the Ethereum wallet. As shown in FIG. 6, the OAuth keys are sent to wallet generation system 606 that may have an encryption algorithm along with multi-party computation. In embodiments, wallet generation system 606 generates the Ethereum wallet which is then accessible by user B from application 602. In alternate embodiments, user B can also access electronic wallet without having to log into application 602. Thus, the electronic wallet can be generated before user B has accessed, logged in, etc., into a particular electronic application associated with user B's user name.

FIG. 7 is an example diagram describing the generation of a digital wallet. As shown in FIG. 7, private keys 702 may be private keys that are retrieved from an OAuth service based on when a user wants to transfer digital assets (associated with a particular account) to another user (who does not have a digital wallet). In embodiments, an electronic wallet generation system 700 (such as associated with wallet generation system 306) is associated with the particular account and may make the request for private keys 702. In embodiments, encryption system 704 may receive the private keys and generate an electronic wallet 706 is web3 based or blockchain based. In embodiments, encryption system 704 may be associated with wallet generation system 306.

FIG. 8 is an example block diagram 800 describing the generation of an Ethereum Virtual Machine (EVM) public address based on a user name associated with a non-blockchain or non-Ethereum based account. In embodiments, an EVM public address private key may be a bytestring of length 64, and is any string of letters a-f and numbers 0-9 with a length of 64. Any string of numbers of letter of any length, like an Oauth token from a login service like twitter, can be cast as a bytestring. An example EVM private key may be a28ef5cd378c4bc6313469fa8224070688a9d78e62f63f35cd3135c3f7577a00. In embodiments, as described in other figures, a user may decide to generate a digital wallet for another user. Upon entering an electronic command into an electronic application that is associated with a digital wallet generation system (such as wallet generation system 306), user name information from block 802 is used to generate OAuth tokens (in block 804) associated with the user name information of the other user (for which the digital wallet is being created for). To send the OAuth tokens, a private key is then generated (as shown in block 804) which is then used for an EVM public address associated with the user for which the digital wallet is being created for. Thus, the electronic wallet can be generated before the other user has accessed, logged in, etc., into a particular electronic application associated with the other user's login information.

FIGS. 9 to 18 show an example process of generating a digital wallet and then accessing the digital wallet. As shown in FIG. 9, the Treasure application is displayed on user device 900 (e.g., similar to user device 302). Two options are shown on the Treasure application 902, icon 904 and 906. Icon 904 allows the user (in this example, John) to use their Treasure application login information while icon 906 allows the user to use the login information associated with another electronic application to log into the Treasure application.

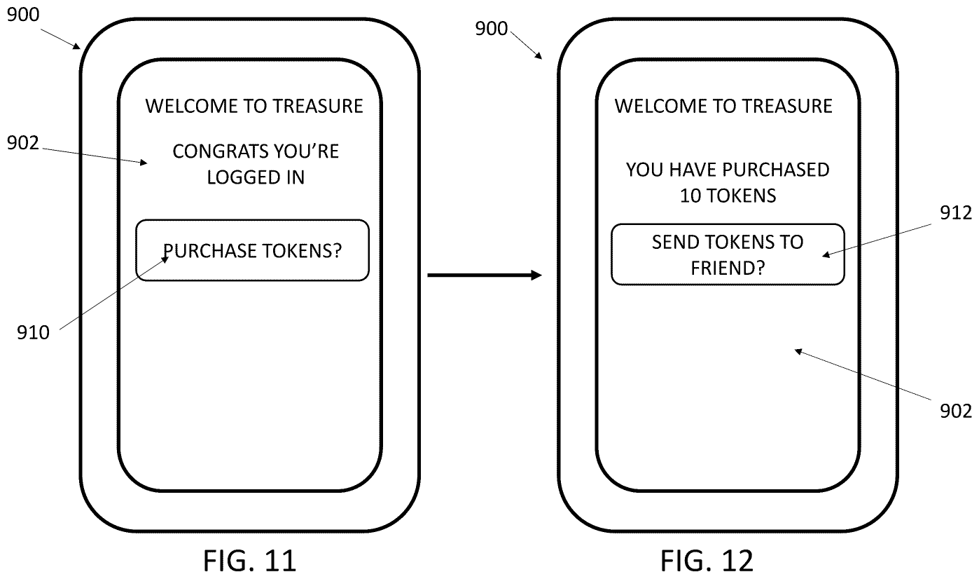

In this non-limiting example, John decides to select icon 906 and use his login information from another application, ABC. Once selected, as shown in FIG. 10, the Treasure application requests John to enter his login information from the ABC application. In this non-limiting example, once John enters the correct user name and password, he is shown the display screen of the Treasure application as shown in FIG. 11. As shown in FIG. 11, the Treasure application displays icon 910 that provides a selection to purchase tokens. John decides to purchase tokens and, as shown in FIG. 12, the Treasure application displays a message that John has purchased 10 tokens. Also, as shown in FIG. 12, the Treasure application displays icon 912 that allows John to send tokens to a friend. In this non-limiting example, John selects icon 912.

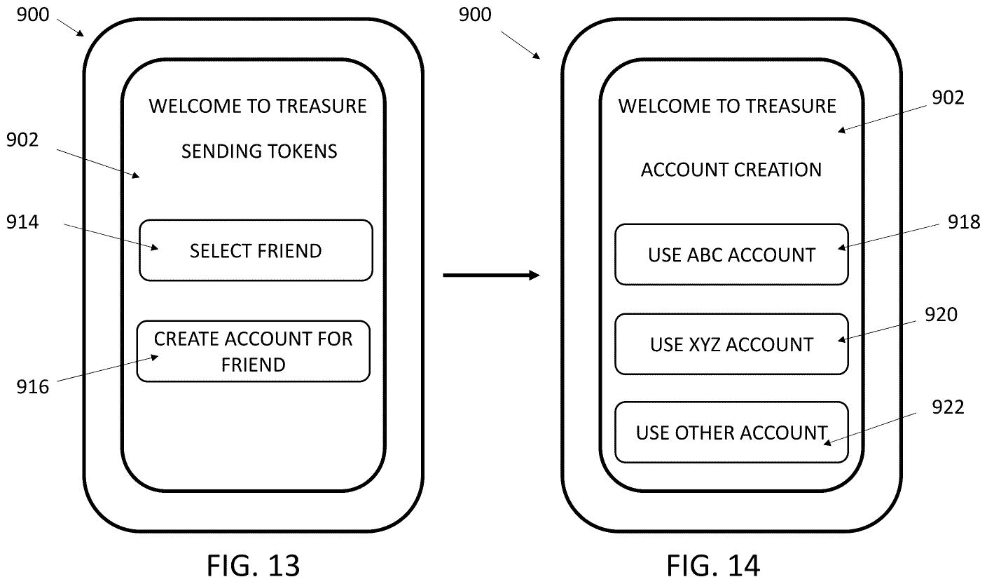

Upon selecting icon 912, the Treasure application provides a new display as shown in FIG. 13. As shown in FIG. 13, John can either select icon 914 (to select a friend who already has an account with the Treasure Application) or icon 916 (to create a new account for a friend). In this non-limiting example, John selects icon 916.

By selecting icon 916, the Treasure application provides a new set of icons (as shown in FIG. 14). As shown in FIG. 14, icons 918, 920, and 922 are displayed. Icon 918 is associated with ABC application, icon 920 is associated with XYZ application, and icon 922 is associated with a user selected account. In this non-limiting example, John selects icon 918 and then enters his friend's name (Mary Smith) as it appears in the ABC application (which John has prior knowledge of). Upon providing Mary Smith's login name information, a digital wallet is generated. In embodiments, the digital wallet may be generated by the Treasure application or may be generated by another system that is associated with the Treasure application and is used to generate the digital wallet.

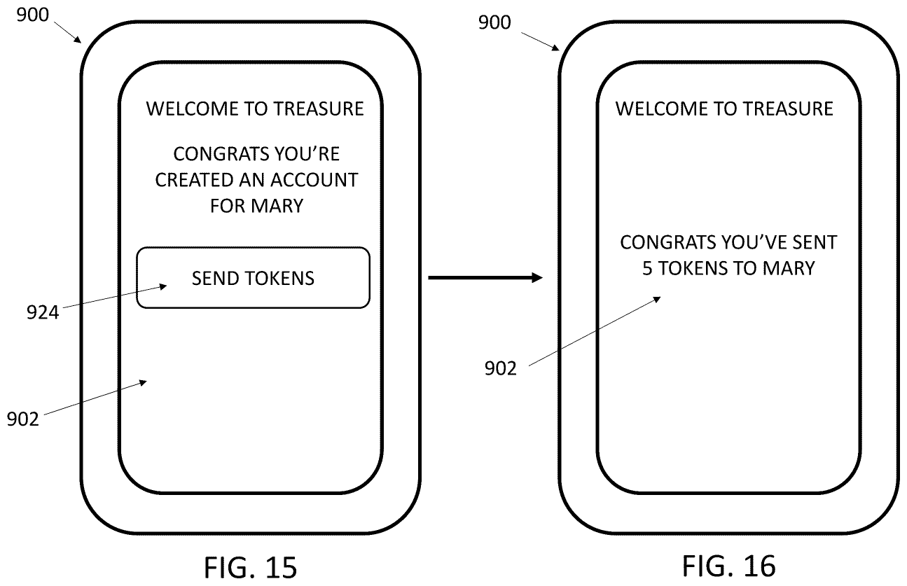

As shown in FIG. 15, the Treasure application displays a message indicating that an account has been created for Mary. As shown in FIG. 15, icon 924 provides an option for John to send the tokens. In this non-limiting example, John selects icon 924 which then shows the display in FIG. 16 which provides a message that tokens are to be sent to Mary. At this point in this non-limiting example, Mary's electronic wallet has been created and does not require Mary to log into any electronic application for the electronic wallet to be generated.

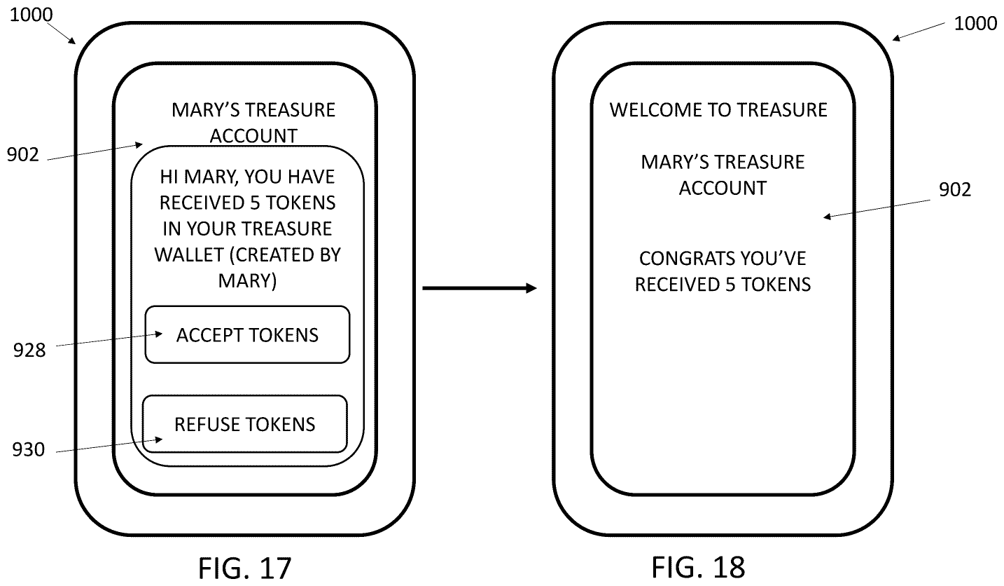

At a later time, Mary logs into Treasure application 902 using her login credentials from the XYZ application as shown. Upon logging into the Treasure application, as shown in FIG. 17, Mary receives a message (on user device 1000 similar to user device 304) that she has received 5 tokens from John and that the tokens are in an electronic wallet (generated for Mary based on John's electronic inputs into the Treasure application). As shown in FIG. 17, icons 928 and 930 provide an option to Mary to accept or refuse the tokens. In this non-limiting example, Mary accepts the tokens and, as shown in FIG. 18, a message is displayed on Treasure application 902 that congratulates Mary on receiving the tokens. Alternatively, Mary can refuse the tokens. If she does so, the tokens may be returned back to John.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 3, to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices as described in FIG. 4. Also, it will be understood that any of the various actions can result in any type of electronic information to be displayed in real-time and/or simultaneously on multiple user devices (e.g., similar to user device 302). It should also be understood that logging into any electronic application may be conducted by either (1) entering login information via a keyboard, mouse, and/or a touchscreen, (2) entering a telephone number, entering email account information, (3) biometric information such as voice activation, (4) biometric information such as facial identification, (6) biometric information such as fingerprint identification, (6) biometric information such as eye/iris information, or a mix of different types of input systems.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An electronic communications method, comprising:
receiving, by a computing device, electronic information associated with an electronic account that is not associated with any blockchain or Web-3; and
generating, by the computing device, an electronic wallet based on the electronic information, wherein the electronic wallet is associated with a particular blockchain and wherein the electronic wallet is associated with another electronic account.

2. The electronic communications method of claim 1, wherein the electronic account is associated with a voice over internet protocol (VoIP) account.

3. The electronic communications method of claim 1, wherein the electronic account is associated with a social networking account.

4. The electronic communications method of claim 1, wherein the electronic account is associated with a wireless phone account.

5. The electronic communications method of claim 1, wherein the generating the electronic wallet includes using private keys associated with the electronic account.

6. The electronic communication method of claim 1, wherein the electronic wallet is configured to receive non-fungible tokens.

7. The electronic communications method of claim 1, wherein the receiving the electronic information is based on receiving an electronic communication to send electronic tokens from another electronic wallet to the electronic wallet.

8. A device, comprising:
memory; and
a processor to:
receive electronic information associated with an electronic account; and
generating an electronic wallet based on the electronic information, wherein the electronic wallet is associated with the electronic account.

9. The device of claim 8, wherein the wherein the electronic account is associated with a social networking account.

10. The device of claim 8, wherein the electronic wallet is associated with a blockchain.

11. The device of claim 8, wherein the electronic wallet is configured to receive electronic tokens.

12. The device of claim 8, wherein the electronic account is not associated with any particular type of blockchain.

13. The device of claim 8, wherein the electronic wallet is associated with Web3 technology while the electronic account is not associated with Web3 technology.

14. The device of claim 8, wherein the electronic wallet is created for another user before the other user logs into the electronic account.
